(19) United States
(12) Patent Application Publication
(10) Pub. No.: US 2009/0150029 A1
(43) Pub. Date: Jun. 11, 2009

(54) CAPACITIVE INTEGRATED MEMS MULTI-SENSOR

(75) Inventors: Ioan Pavelescu, Bucharest (RO); Ion Georgescu, Bucharest (RO); Cornel P. Cobianu, Bucharest (RO); Dana Elena Guran, Bucharest (RO)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/942,592

(22) Filed: Nov. 19, 2007

(51) Int. Cl. B60R 21/00; G01P 15/125; G01P 15/08; G01P 21/00

(52) U.S. Cl. 701/45; 73/514.32; 73/514.31; 73/1.37

(57) ABSTRACT

Apparatus, methods, and systems for incorporating and reading a plurality of bridge sensors is disclosed. The bridge sensors may be capacitive bridge sensors located on the same substrate with a digital processor and signal processing circuits to read the outputs of the sensors. The bridge sensors are accessed by a switch network coupled to the plurality of bridge sensors to selectively provide an output from at least one of the plurality of bridge sensors. The switch network may be a multiplexer, which provides a periodically oscillating voltage to the sensors, to energize the sensors. The multiplexer may also provide output from the energized sensor to the digital processor.

### BACKGROUND

Micro-electro-mechanical systems (MEMS) are well known in the art. MEMS is the technology of the very small, and merges at the nano-scale into nano-electro-mechanical systems (NEMS) and nanotechnology. MEMS are also referred to as micro machines, or Micro Systems Technology (MST). MEMS generally range in size from a micrometer (a millionth of a meter) to a millimeter (a thousandth of a meter).

MEMS technology is finding its way into sensors and is utilized in a number of ways each and every day by electronic and mechanical systems. These systems may determine location, speed, vibration, stress, acceleration, temperature, and a number of other characteristics. Currently, it is common practice to obtain discrete components to determine each of the characteristics the operator or system may wish to measure. Many applications in consumer electronics, automotive electronics, audio/video, camcorders, cameras, cell phones, games/toys, watches, PDAs (personal digital assistant), GPS (global positioning system) handheld devices, medical devices, power supply on/off systems, navigation systems, and other electronic devices may require multiple sensors. Often MEMS sensors are utilized to meet these needs.

MEMS sensors operate under a number of principles utilizing various means to measure properties. There are several physical principles for sensing displacement of mechanical elements, including piezoresistive, capacitive, and piezoelectric methods. To sense displacement of a controlled hot air mass for accelerometry, thermal detection has been used. Inertial sensors have utilized capacitive sensing, as it has generally provided the best displacement resolution with virtually no power dissipated in the transducer element. In capacitive inertial sensors, the motional sensing elements usually take the form of sidewall parallel-plate capacitors oriented in the vertical (perpendicular to substrate) direction, or of sidewall parallel-plate capacitors (also called vertical-axis comb fingers) oriented in the lateral (in-plane to substrate) direction. The sidewall capacitors are usually formed from interdigitated beam fingers (combs), to increase the capacitance in a given layout area. For capacitive sensing the most used principle is the fully differential capacitive bridge

Additional examples of sensing methodologies include hall effect, magneto-resistive, and piezoelectric sensors. An example of magnetic sensors may be found in the article by Beverly Eyre, Kristopher S. J. Pister and William Kaiser, entitled, “Resonant Mechanical Magnetic Sensor In Standard CMOS”. A second example of magnetic sensors may be found in an article by Zsolt Kádár, Andre Bossche and Jeff Mollinger entitled, “Integrated Resonant Magnetic-Field Sensor”.

### BRIEF DESCRIPTION OF THE DRAWINGS

FIG. 1 is a schematic diagram of a fully differential capacitive bridge for displacement detection according to an example embodiment.

FIG. 2 is a schematic diagram of an ASIC having a MEMS multi-sensor according to an example embodiment.

FIG. 3 illustrates an embodiment utilizing a single signal conditioning circuit according to an example embodiment.

FIG. 4 is a schematic diagram of an ASIC having a MEMS multi-sensor according to an example embodiment.

FIG. 5 illustrates a system according to an example embodiment.

FIG. 6 illustrates another system according to an example embodiment.

FIG. 7 is a flow diagram of a method to read the outputs of a plurality of bridge sensors according to an example embodiment.

### DETAILED DESCRIPTION

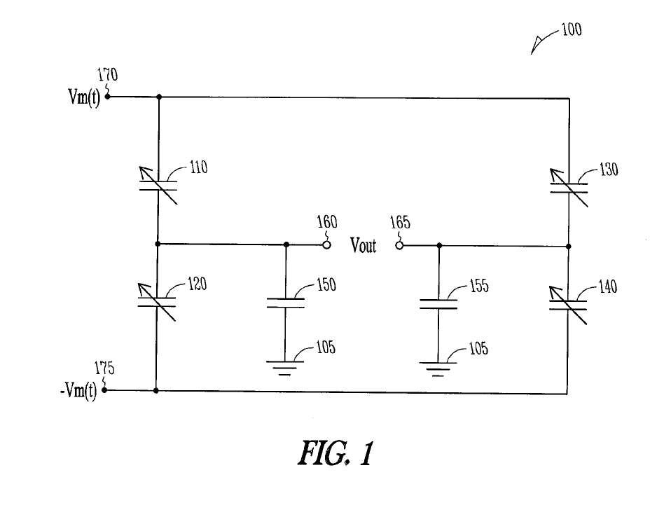

Sensors based upon the capacitive sensing technique may be strain-based sensors, where the displacement of a capacitor electrode due an inertial movement or another force can change the sensing capacitance. A typical configuration is shown in FIG. 1, where the sensor capacitances are arranged in full-bridge configuration. Capacitive sensors utilize a dynamic excitation and capacitive designs normally contain an internal oscillator and signal demodulator to provide static-capable outputs.

FIG. 1 is a schematic diagram of a fully differential capacitive bridge sensor for displacement detection. A capacitive bridge sensor 100 comprises four capacitive sensors 110, 120, 130, and 140 arranged in a bridge. A first end of capacitive sensor 110 is connected to a first end of capacitive sensor 130 and to an alternating current (AC) voltage source Vₘ(t) 170. A first end of capacitive sensor 120 is connected to a first end of capacitive sensor 140 and to a second AC voltage source −Vₘ(t) 175. The voltage sources 170 and 175 may have equal voltages but are 180 degrees out of phase. A second end of capacitive sensor 110 is connected to a second end of capacitive sensor 120 and to an output 160. A second end of capacitive sensor 130 is connected to a second end of capacitive sensor 140 and to an output 165.

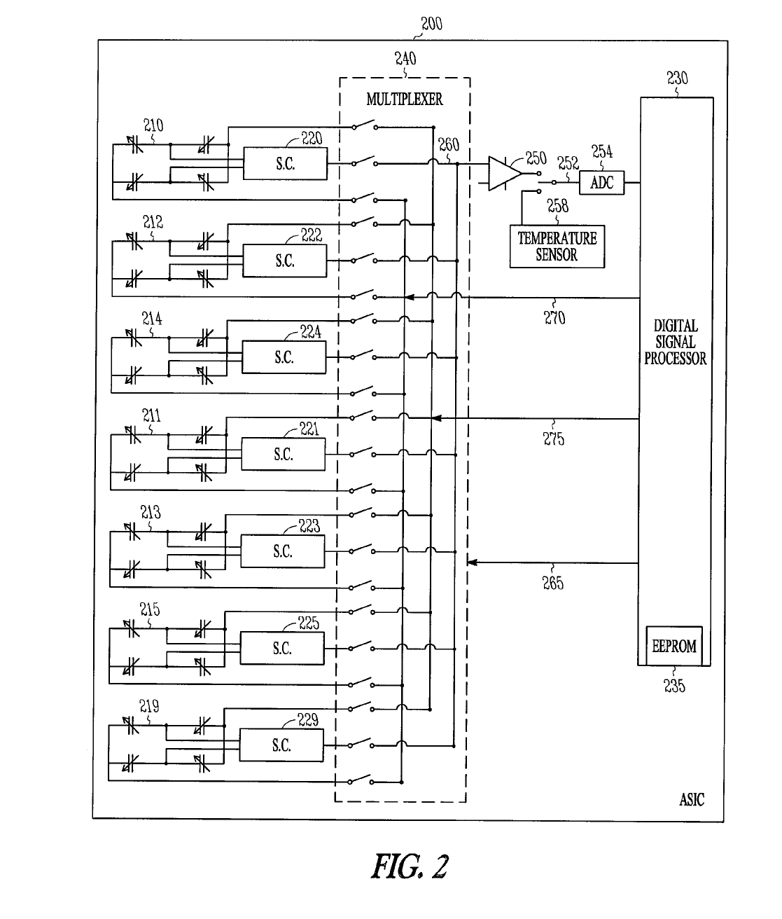

The outputs 160 and 165 are also shown connected to capacitors 150 and 155 respectively. The capacitors 150 and 155 represent the parasitic capacitance and are connected to a ground 105. The voltage differential from outputs 160 and 165 provides the output voltage (Vₒᵤₜ) to a signal conditioning circuit, which is not pictured in FIG. 1 but will be discussed in FIGS. 2, 3, and 4. The signal conditioning circuit may electronically amplify the differential from outputs 160 and 165 from the bridge, thereby increasing the gain. The highest motional sensitivity will be achieved when all four capacitive sensors (110, 120, 130, and 140) in the bridge can change value with the proof mass displacement. Sometimes, two of the capacitors may remain fixed, and in this case motional sensitivity is half that of a fully differential bridge. The voltage sources 170 and 175 provide a balanced AC modulation voltage (sinusoidal or square wave) across the bridge to induce movement in the bridge.

To calculate acceleration for a sensor as depicted in FIG. 1, a simplified formula may be used:

$$\frac{{V}_{out}}{{a}_{ext}} = \frac{1}{x {ω}_{r}^{2}} [ \frac{2 Vm ( {C}_{1} - {C}_{2} )}{{C}_{1} + {C}_{2} + {C}_{p}} ] ≅ \frac{2 Vm}{{ω}_{r}^{2} d ( 1 + \frac{{C}_{p}}{2 {C}_{0}} )}$$

$$where$$

$${C}_{0} = {C}_{i} {\vert}_{x = o} ; i = 1 , 2 , 3 , 4$$

Vₒᵤₜ is the voltage differential from outputs 160 and 165. aₑₓₜ is the external acceleration of the sensor. ωᵣ=2πfᵣ where fᵣ is the modulation frequency of Vₘ and ωᵣ is the un-damped mechanical resonant frequency. The variable d is the gap between the parallel plates of the capacitive bridge when the proof mass is not displaced, and x is the displacement of the proof mass. Cₚ is the parasitic capacitance of the system represented by capacitors 150 and 155. Finally, C₁ represents capacitive sensor 110, C₂ represents capacitive sensor 120, C₃ represents capacitive sensor 130, and C₄ represents capacitive sensor 140. A more detailed explanation of the operation of capacitive bridge sensors may be found in chapters 3 and 11 of the “Advanced Micro and Nanosystems, Volume 2 CMOS-MEMS” Edited by H. Balters, O. Brand, G. K. Fedder, C. Hierold, J. Korvink, and O. Tabata. The inventors have determined that there is a need for a capacitive integrated MEMS multi-sensor for consumer electronics that is able to perform multiple measurements, for example, acceleration, magnetic field, and pressure, based on the capacitive principle. In one embodiment, a packaged multi-sensing one-chip device, may contain, on the same substrate: a three-axis accelerometer, a three-axis magnetic sensor, and a pressure sensor. An advantage of one or more embodiments based on capacitive sensors may include minimal voltage use and reduced size of a sensor system. In one embodiment, all of these sensors may be coupled on the same chip with the use of differential capacitive detection and an application-specific integrated circuit (ASIC). The ASIC may contain signal conditioning circuitry, Electrically Erasable Programmable Read-Only Memory (EEPROM) memory, and an electronic temperature sensor. An external humidity sensor may also be added. In one embodiment, the sensing device may be used in the consumer electronics and automotive electronics applications mentioned above. Low voltage drive and low cost are two important features, which represent a great advantage of this device.

FIG. 2 is a schematic diagram of an ASIC 200 having a MEMS multi-sensor according to an embodiment of the invention. FIG. 2 illustrates ASIC 200 having an integrated MEMS multi-sensing one-chip device, which may contain, on the same chip: a three-axis accelerometer, a three-axis magnetic sensor, and a pressure sensor, all of which utilize differential capacitive detection. The ASIC 200 may also contain signal conditioning circuitry 220, 221, 222, 223, 224, 225, and 229 (referenced as S.C. in FIG. 2), EEPROM 235, and an electronic temperature sensor 258. By designing the system such that the internal sensors use the principle of differential capacitive sensing, a simplified conditioning circuitry by multiplexing the signal from different sensors is possible.

ASIC 200 may include a plurality of sensors. The sensors may include an x-axis magnetic sensor 210, a y-axis magnetic sensor 212, and a z-axis magnetic sensor 214. The sensors may also include an x-axis acceleration sensor 211, a y-axis acceleration sensor 213, and a z-axis acceleration sensor 215.

The ASIC 200 may also include a surface micro-machined capacitive absolute pressure sensor 219. The absolute pressure sensor 219 may be used to detect the absolute atmospheric pressure. As result, an altitude may be calculated from the difference of the known terrestrial atmospheric pressure data of fixed points and the measured pressure.

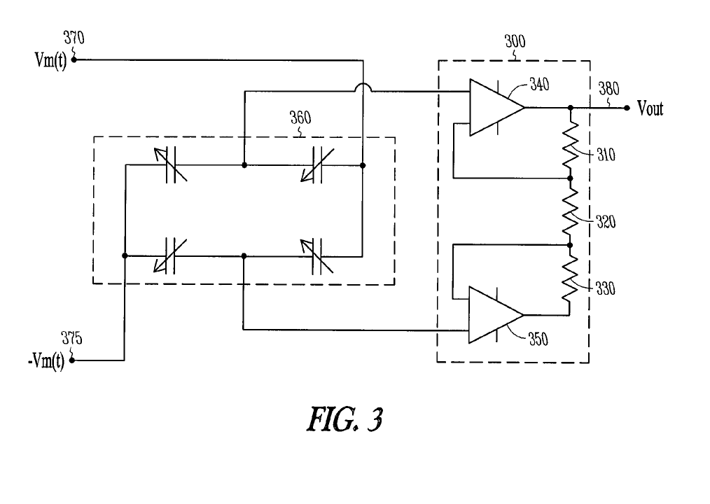

Each of the sensors 210, 211, 212, 213, 214, 215, and 219 are connected to signal conditioning circuits 220, 221, 222, 223, 224, 225, and 229 respectively. An example of a signal conditioning circuit may be found in FIG. 3. The signal conditioning circuits 220, 221, 222, 223, 224, 225, and 229 receive the voltage outputs from the sensors 210, 211, 212, 213, 214, 215, and 219 and adapt the output from the sensors for use by a digital signal processor 230. A switch network such as multiplexer 240 selectively provides an AC voltage source 270 Vₘ(t) of FIG. 1 and an AC voltage source 275 −Vₘ(t) of FIG. 1, to energize a selected sensor. At the same time, multiplexer 240 provides an output 260 from the signal conditioning circuits 220, 221, 222, 223, 224, 225, or 229 of the selected sensor to an amplifier 250. Multiplexer 240 receives an input 265 from digital signal processor 230 to determine which sensor 210, 211, 212, 213, 214, 215, and 219 is activated. Amplifier 250 is connected to a switch 252, which may provide the amplified output from amplifier 250 to an analog-to-digital (ADC) converter 254. Switch 252 may also provide an output from the temperature sensor 258 to the ADC 254. The output of the ADC 254 is provided to digital signal processor 230.

The digital signal processor 230 selects which sensor is energized and which output is provided with selection signal 265 provided to the multiplexer 240. When selection signal 265 is applied the switches are closed for a specific sensor such that AC voltage sources 270 and 275 are applied to a sensor and the signal conditioning circuit for the sensor is connected to the amplifier 250. Operational software may be maintained in the EEPROM 235. The operational software in EEPROM 235 and the signal conditioning circuits 220, 221, 222, 223, 224, 225, and 229 may provide for sensor measurement functions that allow users to receive information from each of the individual sensors without having to know the control methods and arithmetic algorithms involved for various sensors such as magnetic or geomagnetic vector, acceleration, tilt angle, atmospheric pressure, humidity, or temperature. In addition, EEPROM 235 may be programmed to adjust measurements of the properties measured based on other property measurements. For example, by measuring acceleration, a truer magnetic reading may be obtained.

FIG. 3 illustrates an embodiment of the invention utilizing a single signal conditioning circuit. ASIC 300 may include two amplifiers 340 and 350, and three resistors 310, 320, and 330. Resistor 310 is connected at a first end to the output of amplifier 340, and at a second end to a first end of resistor 320 and to a negative input for amplifier 340. Resistor 320 is connected from resistor 310 to resistor 330. Resistor 330 is connected at a first end to the negative input for amplifier 350 and resistor 320, and at a second end to an output of amplifier 350. The positive input for amplifier 340 is connected to a first output of sensor bridge 360. The positive input for amplifier 350 is connected to a second output of sensor bridge 360. Voltage supplies 370 and 375 provide an oscillating voltage to the sensor bridge 360. The output of amplifier 340 is also provided as an output 380 for the ASIC 300. While FIG. 3 is representative of one signal conditioning circuit, other circuits may be used dependent upon the sensor bridge utilized and the requirements of the ASIC.

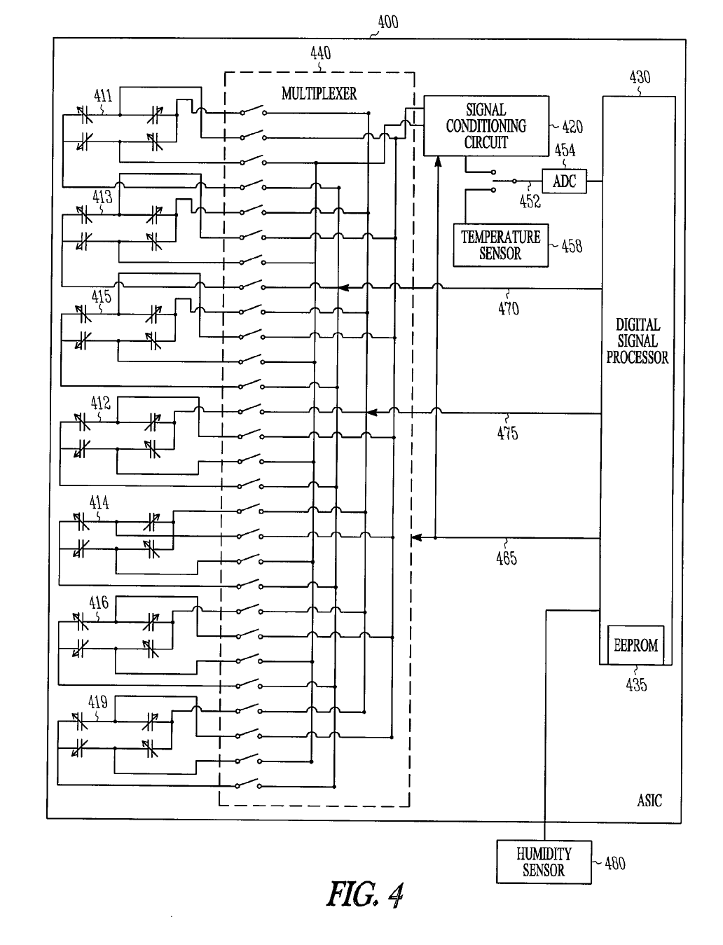

FIG. 4 is a schematic diagram of an ASIC 400 having a MEMS multi-sensor according to an embodiment of the invention. ASIC 400 may include a plurality of sensors. The sensors may include an x-axis magnetic sensor 411, a y-axis magnetic sensor 413, and a z-axis magnetic sensor 415. The sensors may also include an x-axis acceleration sensor 412, a y-axis acceleration sensor 414, and a z-axis acceleration sensor 416. The ASIC 400 may also include a surface micro-machined capacitive absolute pressure sensor 419.

Each of the sensors 411, 412, 413, 414, 415, 416 and 419 are connected to a multiplexer 440. A switch network such as multiplexer 440 selectively provides an AC voltage source 470 and an AC voltage source 475 to energize a selected sensor. At the same time, multiplexer 440 provides outputs 462 and 464 from one of the sensors 411, 412, 413, 414, 415, 416 and 419 to signal conditioning circuit 420. Multiplexer 440 receives an input 465 from digital signal processor 430 to determine which sensor 411, 412, 413, 414, 415, 416 or 419 is activated. Signal conditioning circuit 420 is connected to a switch 452, which may provide the conditioned output from signal conditioning circuit 420 to an analog-to-digital converter (ADC) 454. Switch 452 may also provide an output from a temperature sensor 458 to the ADC 454. The output of the ADC 454 is provided to digital signal processor 430.

The digital signal processor 430 selects which sensor is energized and which output is provided with selection signal 465 provided to the multiplexer 440. When selection signal 465 is applied the switches are closed for a specific sensor such that AC voltage sources 470 and 475 are applied to a sensor and the output of that sensor is provided to the signal conditioning circuit 420. Operational software may be maintained in an EEPROM 435. The operational software in EEPROM 435 and the signal conditioning circuit 420 may provide for sensor measurement functions. This will allow users to receive information from each of the individual sensors without having to know the control methods and arithmetic algorithms involved for various sensors such as magnetic or geomagnetic vector, acceleration, tilt angle, atmospheric pressure, humidity, or temperature. In addition, EEPROM 435 may be programmed to adjust measurements of the measured properties based on other property measurements. For example, by measuring acceleration, a truer magnetic reading may be obtained. In addition, digital signal processor 430 may also be connected to a humidity sensor 480 that may be external to the ASIC 400.

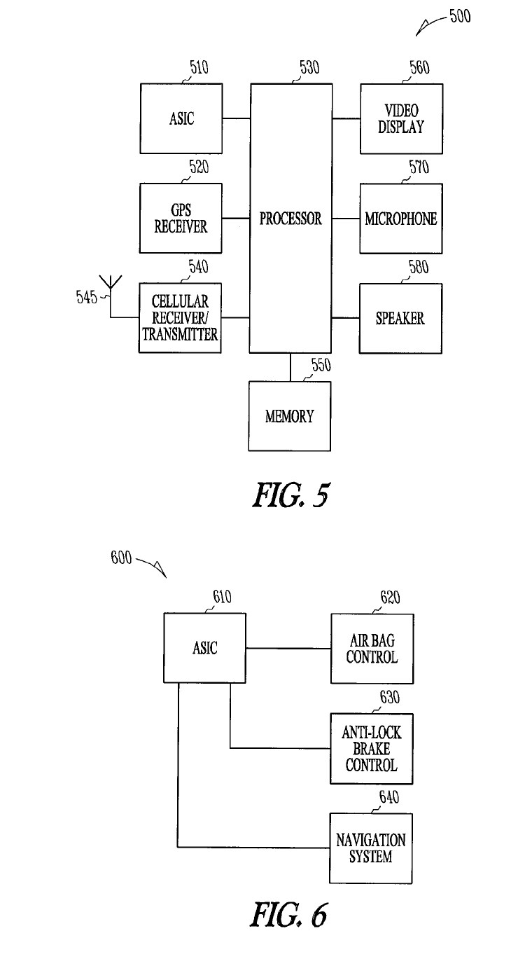

FIG. 5 illustrates a system incorporating an embodiment of the invention. The system 500 may include a processor 530 for processing inputs and providing outputs. Processor 530 may receive an output from an ASIC 510 in accordance with an embodiment of the invention as described in FIGS. 2 and 4. Processor 530 may also receive an input from a Global Positioning System (GPS) receiver 520. GPS receiver 520 may have errors introduced into its determination of location due to signal reflections or intentional errors introduced by a GPS transmitter. To determine if an error has occurred, system 500 may begin at a known location and then calibrate corrections for errors in data received by GPS receiver 520. As the system 500 moves, ASIC 510 may track acceleration and magnetic field movement, and these data may be used to correct for additional errors in data received by GPS receiver 520.

System 500 may also include a cellular receiver/transmitter 540 connected to an antenna 545. The cellular receiver/transmitter 540 may be connected to processor 530. System 500 may also include a memory 550 to store data from ASIC 510, as well as a video display 560 to display information derived by ASIC 510. Memory 550 may be located on the same substrate as ASIC 510. In addition, system 500 may include a microphone 570 and a speaker 580 to permit voice control or inputs to and from processor 530. For example, if system 500 were a cellular phone, ASIC 510 may be useful in determining the location of system 500.

FIG. 6 illustrates another system incorporating an embodiment of the invention. System 600 may be utilized in a moving vehicle such as an automobile. ASIC 610 may provide information to one or more of the following: an airbag control 620, an anti-lock brake control 630, or a navigation system 640. The ASIC may provide acceleration data to the airbag control 620 indicating when the airbag should deploy. In addition, the ASIC 610 may provide both acceleration and magnetic positional information to the anti-lock brake control 630 to indicate the anti-lock brake system should be activated. Finally, the ASIC 610 may provide additional navigational data to the navigation system 640, for example as discussed in FIG. 5, the ASIC may correct for errors from the GPS system.

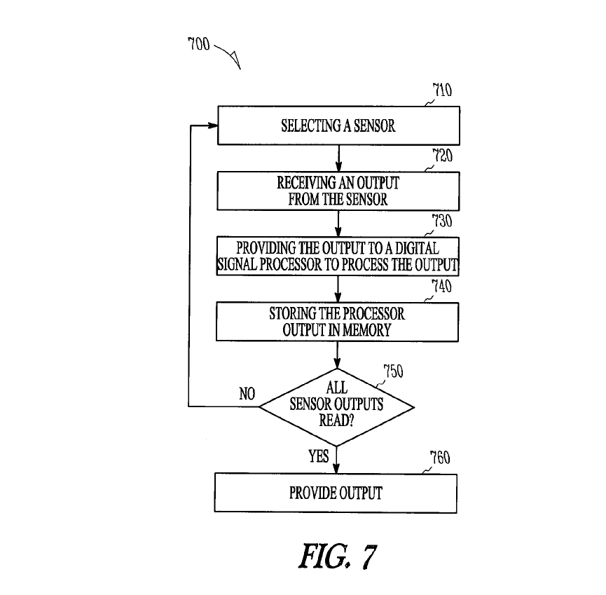

FIG. 7 is a flow diagram of a method 700 to read the outputs of a plurality of bridge sensors. The method 700 may include activity 710 to select a sensor to be activated and read. This may be done with a multiplexer as described and shown in FIGS. 2 and 4. Activity 720 may be to receive an output from the sensor. Activity 730 may be to provide the output to a digital signal processor to process the output. Activity 740 may be to store the processor output in memory, such as memory 550 of FIG. 5. Activity 750 may be to determine if all of the sensors have been read. If so, activity 760 may be to provide an output from the apparatus. If not, activity 710 may again be initiated and the method repeated until all of the sensors are read.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. The above description and figures illustrate embodiments of the invention to enable those skilled in the art to practice the embodiments of the invention. Thus, the following claims are hereby incorporated into the Detailed Description, with each claim standing on its own as a separate embodiment.

What is claimed is:

1. An apparatus comprising:
a plurality of capacitive bridge sensors;
a switch network coupled to the plurality of bridge sensors to selectively provide an output from at least one of the plurality of bridge sensors.

2. The apparatus of claim 1, comprising a signal conditioning circuit coupled to the switch network, wherein the switch network selectively provides the output from at least one of the plurality of bridge sensors to the signal conditioning circuit.

3. The apparatus of claim 1, wherein the plurality of bridge sensors include a signal conditioning circuit.

4. The apparatus of claim 1, wherein the switch network comprises a multiplexer.

5. The apparatus of claim 4, wherein the multiplexer is coupled to a voltage source and selectively provides a voltage from the voltage source to a sensor.

6. The apparatus of claim 5, comprising a signal conditioning circuit coupled to the switch network, wherein the switch network selectively provides the output from at least one of the plurality of bridge sensors to the signal conditioning circuit.

7. The apparatus of claim 5, wherein the plurality of bridge sensors include a signal conditioning circuit.

8. The apparatus of claim 1, further comprising a digital signal processor, coupled to the switch network.

9. The apparatus of claim 8, wherein the switch network is a multiplexer and the digital signal processor selects which of the plurality of bridge sensors the multiplexer selectively provides the output from.

10. The apparatus of claim 1, wherein the plurality of bridge sensors comprises an acceleration sensor.

11. The apparatus of claim 1, wherein the plurality of bridge sensors comprises a magnetic sensor.

12. The apparatus of claim 11, wherein the plurality of bridge sensors comprises an acceleration sensor.

13. The apparatus of claim 12, wherein the switch network comprises a multiplexer.

14. The apparatus of claim 13, wherein the plurality of bridge sensors includes a signal conditioning circuit.

15. The apparatus of claim 14, wherein the apparatus is located on a silicon wafer.

16. The apparatus of claim 14, further comprising a digital signal processor coupled to the switch network.

17. The apparatus of claim 16, further comprising an airbag control, wherein a digital signal processor provides an output to the airbag control.

18. The apparatus of claim 16, further comprising an anti-lock brake control, wherein a digital signal processor provides an output to the anti-lock brake control.

19. The apparatus of claim 16, further comprising a navigation system, wherein a digital signal processor provides an output to the navigation system.

20. A method comprising:
selecting a first sensor from of a plurality of capacitive bridge sensors;
receiving an output from the first sensor;
selecting a second sensor from the plurality of capacitive bridge sensors;
receiving an output from the second sensor;

21. The method of claim 20, further comprising, providing a voltage source to the first sensor when the first sensor is selected and providing a voltage source to the second sensor when the second sensor is selected.

22. The method of claim 20, further comprising, providing the output of the first and second sensor to a signal conditioning circuit.

23. The method of claim 20, further comprising, calibrating the output of the first sensor with the output of the second sensor.
